(19) United States
(12) Patent Application Publication
(10) Pub. No.: US 2022/0271946 A1
(43) Pub. Date: Aug. 25, 2022

(54) Over-the-Air CBRS Certificate Installation

(71) Applicant: AT&T Intellectual Property I, L.P., Atlanta, GA (US)

(72) Inventors: Vazrik Hovsepian, Carrollton, TX (US); David Lewis, Freehold, NJ (US)

(73) Assignee: AT&T Intellectual Property I, L.P., Atlanta, GA (US)

(21) Appl. No.: 17/179,454

(22) Filed: Feb. 19, 2021

(51) Int. Cl. H04L 9/32; H04L 9/08

(52) U.S. Cl. CPC H04L 9/3263; H04L 9/3247; H04L 9/3226; H04L 9/0825; H04L 9/085

(57) ABSTRACT

Concepts and technologies are disclosed herein for over-the-air CBRS certificate installation. A device can detect a connection with a user device via a non-CBRS communication band. The device can authenticate the user device to communicate with the device. The device can receive a request for a CBRS certificate where the request for the CBRS certificate can be signed by the user device using a private key. The device can determine if the user device is in possession of an authorized private key, and in response to a determination that the user device is in possession of the authorized private key, obtaining, by the processor and from a CBRS certificate hosting server, the CBRS certificate. The device can provide the CBRS certificate to the user device.

### BACKGROUND

Service providers planning to launch a citizens broadband radio service (“CBRS”) ecosystem typically select one of the approved CBRS certificate vendors from among the multiple CBRS root certified authority (“CA”) operators. Generally, service providers enter into a business agreement with the chosen CBRS root certified authority operator, and the service provider purchases a bulk of CBRS certificates.

CBRS certificates become available for release to the selected subscriber (e.g., a device manufacturer) after the subscriber has completed and signed the digital certificate subscriber agreement (“DCSA”) or DCSA form of the CBRS root certified authority operator. The CBRS certificates can be preordered in bulk and downloaded by the subscriber from the CBRS root certified authority operator website using an assigned username and password.

The subscriber can store the downloaded CBRS certificates in a secure server, in some embodiments. At the time of device installation, SAS can use the device certificate embedded in a CBRS device (“CBSD”) to authenticate the device requesting services from the server. Generally, there are two ways today that the CBRS certificates can be added to wireless devices (e.g., fixed wireless device). First, a post production process can be employed to add a CBRS certificate one at a time individually via connecting a computer device to the fixed wireless product and manually adding the certificate using trusted software of the computer device.

Alternatively, a during production process can entail adding CBRS certificates to the devices in a production line after the fixed wireless device has been produced in an automated fashion. If the device is lost, damaged, or malfunctions, the CBRS certificate will be lost. Additionally, or alternatively, these processes can be time-consuming and resource-consuming.

### SUMMARY

The present disclosure is directed to over-the-air CBRS certificate installation. Instead of requiring a user device to be in a particular location connected to a particular device to install the CBRS certificate, a user device can be configured to obtain and install a CBRS certificate over-the-air (e.g., using a broadband wireless connection) at any location instead of necessarily being provisioned with the CBRS certificate prior to shipping. The user device can be configured to support a trusted execution environment, for example, by a processor, a component or portion of a processor, and/or by other hardware and/or software. The user device can be configured to execute, in the trusted execution environment, a CBRS application that can be configured to obtain and install the CBRS certificate. In particular, the user device can be configured, e.g., via execution of the CBRS application, to communicate with a CBRS certificate service to obtain the CBRS certificate.

According to various embodiments of the concepts and technologies disclosed herein, the user device can store CBRS credentials in a secure memory. These CBRS credentials can be provisioned prior to shipping the user device, in some embodiment, or installed or stored at the user device at other times. The CBRS credentials can include, for example, a private key, a login, a password, a token, and/or other credentials that can be used to obtain the CBRS certificate. The secure memory can protect the private key, login, password, token, and/or other credentials from unauthorized access, and by shipping the user device without the CBRS certificate pre-provisioned and/or stored, the CBRS certificate can be protected from unauthorized access, non-use in the event of a loss or failure of the user device, and/or other possible benefits that may or may not apply in some embodiments of the concepts and technologies disclosed herein.

The user device can be configured, for example via execution of the CBRS application, to detect a powering on of the user device at a first use of the user device, during a setup of the user device, and/or at other times. The CBRS application can cause the user device to scan for a non-CBRS communication band such as an LTE connection, a 5G connection, or the like, and to connect to the non-CBRS communication band. The user device can register with a network via the non-CBRS communication band to enable communications with a CBRS certificate service (e.g., hosted and/or executed by a server computer) and/or other entities.

The user device can be configured to authenticate with the CBRS certificate service and/or the server computer. In some embodiments, for example, the user device can provide a username and/or password to the server computer for authentication. In some other embodiments, the user device may provide a token and/or other data to authenticate with the server computer. Once the user device has been authenticated by the server computer, the user device can communicate with the server computer and/or with the CBRS certificate hosting server to obtain a CBRS certificate.

In some embodiments, the user device can communicate with the server computer via a portal, API, or other functionality that can be exposed by the server computer. The server computer also can be configured to support representational state transfer (“REST”), for example RESTful API calls, by which the user device can effectively communicate with the CBRS certificate hosting server via one or more API calls and/or portal interactions with the server computer. In particular, the user device can communicate with the CBRS certificate hosting server via the server computer to create a certificate signing request. This certificate signing request can be signed with a private key, which in some embodiments may be stored in the secure memory of the user device and/or that can be obtained by the user device via communications with the server computer and/or the CBRS certificate hosting server. The CBRS certificate hosting server can be configured to determine if the private key used to sign the certificate signing request is signed with the appropriate private key. If so, the CBRS certificate hosting server can be configured to issue the CBRS certificate for use by the user device.

In some embodiments, the CBRS certificate hosting server can be configured to issue the CBRS certificate to the server computer, and the server computer can forward the CBRS certificate to the user device (e.g., via the API, portal, etc.). The user device can perform operations (e.g., by executing the CBRS application, via instructions from an installation technician, etc.) to connect to the CBRS communication band of the network and to install the CBRS certificate at the user device. In some embodiments, the CBRS certificate can be stored in the secure memory, though this is not necessarily the case in all embodiments. The user device can connect to one or more computing devices (e.g., an Internet-of-things device, a gateway, a computer, etc.) via the CBRS communication band, and can be authorized for CBRS communications using the CBRS certificate.

According to one aspect of the concepts and technologies disclosed herein, a system is disclosed. The system can include a processor and a memory. The memory can store computer-executable instructions that, when executed by the processor, cause the processor to perform operations. The operations can include detecting, at a device, a connection with a user device via a non-CBRS communication band, authenticating the user device to communicate with the device, and receiving a request for a CBRS certificate. The request for the CBRS certificate can be signed by the user device using a private key. The operations further can include determining, based on the private key, if the user device is in possession of an authorized private key, in response to a determination that the user device is in possession of the authorized private key, obtaining, from a CBRS certificate hosting server, the CBRS certificate, and providing, to the user device, the CBRS certificate.

In some embodiments, obtaining the CBRS certificate can include passing an application programming interface call to the CBRS certificate hosting server to request the CBRS certificate from the CBRS certificate hosting server. In some embodiments, the application programming interface call can include a representational state transfer application programming interface call.

In some embodiments, the non-CBRS communication band can include a long term evolution communication band that is not long term evolution band forty-eight, and the CBRS communication band can include the long term evolution band forty-eight. In some embodiments, authenticating the user device can include challenging the user device for a login and password that were stored in a secure memory of the user device by a device manufacturer. The user device can be configured to store the CBRS certificate in the secure memory of the user device.

According to another aspect of the concepts and technologies disclosed herein, a method is disclosed. The method can include detecting, at a device that can include a processor, a connection with a user device via a non-CBRS communication band; authenticating, by the processor, the user device to communicate with the device; and receiving, by the processor, a request for a CBRS certificate. The request for the CBRS certificate can be signed by the user device using a private key. The method further can include determining, by the processor and based on the private key, if the user device is in possession of an authorized private key; in response to a determination that the user device is in possession of the authorized private key, obtaining, by the processor and from a CBRS certificate hosting server, the CBRS certificate; and providing, by the processor and to the user device, the CBRS certificate.

In some embodiments, determining that the user device is in possession of the private key can include determining if a copy of the private key stored by the device matches the private key used to sign the request for the CBRS certificate. In some embodiments, obtaining the CBRS certificate can include passing an application programming interface call to the CBRS certificate hosting server to request the CBRS certificate from the CBRS certificate hosting server. In some embodiments, the application programming interface call can include a representational state transfer application programming interface call.

In some embodiments, the non-CBRS communication band can include a long term evolution communication band that is not long term evolution band forty-eight. In some embodiments, the CBRS communication band can include the long term evolution band forty-eight. In some embodiments, authenticating the user device can include challenging the user device for a login and password that were stored in a secure memory of the user device by a device manufacturer. In some embodiments, the user device can be configured to store the CBRS certificate in the secure memory of the user device. In some embodiments, the user device can be configured to execute a CBRS application in a trusted execution environment to sign the request for the CBRS certificate.

According to yet another aspect of the concepts and technologies disclosed herein, a computer storage medium is disclosed. The computer storage medium can store computer-executable instructions that, when executed by a processor, cause the processor to perform operations. The operations can include detecting, at a device, a connection with a user device via a non-CBRS communication band, authenticating the user device to communicate with the device, and receiving a request for a CBRS certificate. The request for the CBRS certificate can be signed by the user device using a private key. The operations further can include determining, based on the private key, if the user device is in possession of an authorized private key, in response to a determination that the user device is in possession of the authorized private key, obtaining, from a CBRS certificate hosting server, the CBRS certificate, and providing, to the user device, the CBRS certificate.

In some embodiments, determining that the user device is in possession of the private key can include determining if a copy of the private key stored by the device matches the private key used to sign the request for the CBRS certificate. In some embodiments, obtaining the CBRS certificate can include passing an application programming interface call to the CBRS certificate hosting server to request the CBRS certificate from the CBRS certificate hosting server. In some embodiments, the application programming interface call can include a representational state transfer application programming interface call.

In some embodiments, the non-CBRS communication band can include a long term evolution communication band that is not long term evolution band forty-eight. In some embodiments, the CBRS communication band can include the long term evolution band forty-eight. In some embodiments, the user device can be configured to store the CBRS certificate in a secure memory of the user device. In some embodiments, the user device can be configured to execute a CBRS application in a trusted execution environment to sign the request for the CBRS certificate.

Other systems, methods, and/or computer program products according to embodiments will be or become apparent to one with skill in the art upon review of the following drawings and detailed description. It is intended that all such additional systems, methods, and/or computer program products be included within this description and be within the scope of this disclosure.

### BRIEF DESCRIPTION OF THE DRAWINGS

FIG. 1 is a system diagram illustrating an illustrative operating environment for various embodiments of the concepts and technologies described herein.

FIG. 2 is a flow diagram showing aspects of a method for installing a CBRS certificate at a user device, according to an illustrative embodiment of the concepts and technologies described herein.

FIG. 3 is a flow diagram showing aspects of a method for providing a CBRS certificate to a user device for installation, according to an illustrative embodiment of the concepts and technologies described herein.

FIG. 4 schematically illustrates a network, according to an illustrative embodiment of the concepts and technologies described herein.

FIG. 5 is a block diagram illustrating an example computer system configured to provide over-the-air CBRS certificate installation, according to some illustrative embodiments of the concepts and technologies described herein.

FIG. 6 is a block diagram illustrating an example mobile device configured to provide over-the-air CBRS certificate installation, according to some illustrative embodiments of the concepts and technologies described herein.

FIG. 7 is a diagram illustrating a computing environment capable of implementing aspects of the concepts and technologies disclosed herein, according to some illustrative embodiments of the concepts and technologies described herein.

### DETAILED DESCRIPTION

The following detailed description is directed to over-the-air CBRS certificate installation. A user device can be configured to obtain and install a CBRS certificate instead of necessarily being provisioned with the CBRS certificate prior to shipping. The user device can be configured to support a trusted execution environment, for example, by a processor, a component or portion of a processor, and/or by other hardware and/or software. The user device can be configured to execute, in the trusted execution environment, a CBRS application that can be configured to obtain and install the CBRS certificate. In particular, the user device can be configured, e.g., via execution of the CBRS application, to communicate with a CBRS certificate service to obtain the CBRS certificate.

According to various embodiments of the concepts and technologies disclosed herein, the user device can store CBRS credentials in a secure memory. These CBRS credentials can be provisioned prior to shipping the user device, in some embodiments, or installed or stored at the user device at other times. The CBRS credentials can include, for example, a private key, a login, a password, a token, and/or other credentials that can be used to obtain the CBRS certificate. The secure memory can protect the private key, login, password, token, and/or other credentials from unauthorized access, and by shipping the user device without the CBRS certificate pre-provisioned and/or stored, the CBRS certificate can be protected from unauthorized access, non-use in the event of a loss or failure of the user device, and/or other possible benefits that may or may not apply in some embodiments of the concepts and technologies disclosed herein.

The user device can be configured, for example via execution of the CBRS application, to detect a powering on of the user device at a first use of the user device, during a setup of the user device, and/or at other times. The CBRS application can cause the user device to scan for a non-CBRS communication band such as an LTE connection, a 5G connection, or the like, and to connect to the non-CBRS communication band. The user device can register with a network via the non-CBRS communication band to enable communications with a CBRS certificate service (e.g., hosted and/or executed by a server computer) and/or other entities.

The user device can be configured to authenticate with the CBRS certificate service and/or the server computer. In some embodiments, for example, the user device can provide a username and/or password to the server computer for authentication. In some other embodiments, the user device may provide a token and/or other data to authenticate with the server computer. Once the user device has been authenticated by the server computer, the user device can communicate with the server computer and/or with the CBRS certificate hosting server to obtain a CBRS certificate.

In some embodiments, the user device can communicate with the server computer via a portal, API, or other functionality that can be exposed by the server computer. The server computer also can be configured to support RESTful API calls, by which the user device can effectively communicate with the CBRS certificate hosting server via one or more API calls and/or portal interactions with the server computer. In particular, the user device can communicate with the CBRS certificate hosting server via the server computer to create a certificate signing request. This certificate signing request can be signed with a private key, which in some embodiments may be stored in the secure memory of the user device and/or that can be obtained by the user device via communications with the server computer and/or the CBRS certificate hosting server. The CBRS certificate hosting server can be configured to determine if the private key used to sign the certificate signing request is signed with the appropriate private key. If so, the CBRS certificate hosting server can be configured to issue the CBRS certificate for use by the user device.

In some embodiments, the CBRS certificate hosting server can be configured to issue the CBRS certificate to the server computer, and the server computer can forward the CBRS certificate to the user device (e.g., via the API, portal, etc.). The user device can perform operations (e.g., by executing the CBRS application, via instructions from an installation technician, etc.) to connect to the CBRS communication band of the network and to install the CBRS certificate at the user device. In some embodiments, the CBRS certificate can be stored in the secure memory, though this is not necessarily the case in all embodiments. The user device can connect to one or more computing devices (e.g., an Internet-of-things device, a gateway, a computer, etc.) via the CBRS communication band, and can be authorized for CBRS communications using the CBRS certificate.

As used herein and in the claims, the abbreviation “CBRS” is used to refer to the citizens broadband radio service. The citizens broadband radio service is generally known, and includes radio frequency (“RF”) spectrum from about 3.5 GHz to 3.7 GHz that has been designated by the Federal Communications Commission (“FCC”) for sharing among incumbent users, priority licensees, and lightly licensed users. As such, CBRS is not further described herein in additional detail.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

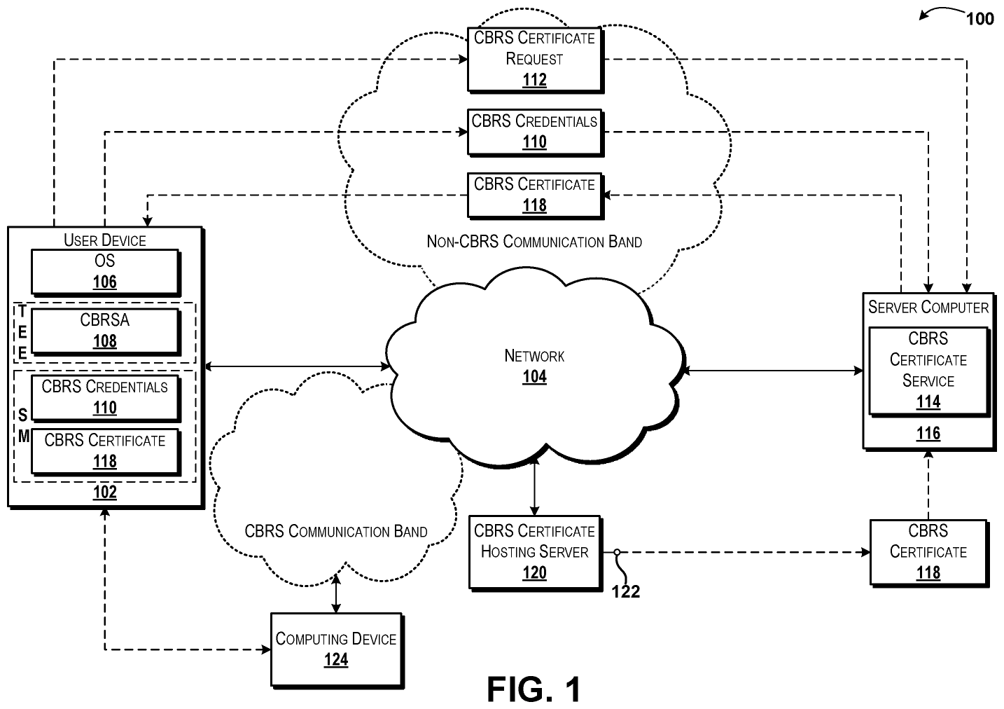

Referring now to FIG. 1, aspects of an operating environment 100 for various embodiments of the concepts and technologies disclosed herein for over-the-air CBRS certificate installation will be described, according to an illustrative embodiment. The operating environment 100 shown in FIG. 1 includes a user device 102. The user device 102 can operate in communication with and/or as a part of a communications network (“network”) 104, though this is not necessarily the case in all embodiments of the concepts and technologies disclosed herein. As shown in FIG. 1, the network 104 can support various bands and/or communication standards, paths, and/or technologies including, but not limited to, a CBRS communication band (e.g., long term evolution (“LTE”) band forty-eight (“LTE band 48”)) and a non-CBRS communication band (e.g., at least one other LTE band that is not LTE band 48). It should be understood that this example is illustrative, and therefore should not be construed as being limiting in any way.

According to various embodiments, the functionality of the user device 102 may be provided by one or more server computers, desktop computers, mobile telephones, laptop computers, smartphones, other computing systems, and the like. According to various embodiments of the concepts and technologies disclosed herein, the user device 102 can be configured to communicate via a CBRS communication band and one or more non-CBRS communication bands. It should be understood that the functionality of the user device 102 can be provided by a single device, by two or more similar devices, and/or by two or more dissimilar devices. For purposes of describing the concepts and technologies disclosed herein, the user device 102 is described herein as a wireless device such as a smartphone or tablet computer that is configured to communicate via a CBRS communication band and a non-CBRS communication band. It should be understood that this embodiment is illustrative, and therefore should not be construed as being limiting in any way.

The user device 102 can execute an operating system 106 and one or more application programs such as, for example, a CBRS application 108 (labeled “CBRSA 108” in FIG. 1). The operating system 106 can include a computer program for controlling the operation of the user device 102. The CBRS application 108 can include an executable program that can be configured to execute on top of the operating system 106 to provide various functions as illustrated and described for providing over-the-air installation of a CBRS certificate, as will be illustrated and described in further detail herein.

According to various embodiments of the concepts and technologies disclosed herein, the user device 102 or one or more components thereof (e.g., a processor, a portion of a processor, etc.) can provide and/or use a trusted execution environment (schematically illustrated in FIG. 1 and labeled “TEE”). In some embodiments, the CBRS application 108 can be executed within the trusted execution environment. It should be understood that this example is illustrative, and therefore should not be construed as being limiting in any way.

In some embodiments, the user device 102 or one or more components thereof (e.g., a memory, a portion of a memory, etc.) can provide and/or use a secure memory (schematically illustrated in FIG. 1 and labeled “SM”). In some embodiments, code for providing the CBRS application 108 can be stored in the secure memory and retrieved for execution within the trusted execution environment, though this is not necessarily the case in all embodiments. Additionally, the CBRS application 108 can use and/or access the secure memory for various reasons as will be illustrated and described herein in more detail. For example, the CBRS application 108 can be configured to retrieve and/or store one or more keys or credentials such as the CBRS credentials 110 in the secure memory. As will be explained in more detail herein, the user device 102 also can, via execution of the CBRS application 108, obtain and store other certificates and/or keys in the secure memory or regular memory, as will be explained herein with regard to a certificate to enable communications via the CBRS communication band of the network 104. It should be understood that this example is illustrative, and therefore should not be construed as being limiting in any way.

In particular, the CBRS application 108 can be configured to obtain and install a certificate to enable CBRS communications by communicating with a certificate authority and/or service. Whereas previous technologies entail installing a certificate in a device such as the user device 102 during manufacturing, or the like, embodiments of the concepts and technologies disclosed herein enable the user device 102 to obtain, install, and use the certificate after delivery to a user or other entity and/or at other times as explained herein. It should be understood that this example is illustrative, and therefore should not be construed as being limiting in any way.

In particular, the CBRS application 108 can be configured to perform various operations. In some embodiments, the CBRS application 108 can be configured to detect a power up or power on of the user device 102. Upon detecting the powering on of the user device 102, the CBRS application 108 can cause the user device 102 to scan for a non-CBRS communication band of the network 104. For example, the non-CBRS communication band of the network 104 can include an LTE communication band other than LTE band 48, or another communication band supported by other technologies and/or standards and/or protocols. According to various embodiments of the concepts and technologies disclosed herein, the non-CBRS communication band can support secure data transmissions between the user device 102 and one or more other devices. The CBRS application 108 can cause the user device 102 to connect to the non-CBRS communication band and register with the network 104 to enable the data communications via the non-CBRS communication band. It should be understood that this example is illustrative, and therefore should not be construed as being limiting in any way.

The CBRS application 108 also can be configured to generate a CBRS certificate request 112, which can be sent to one or more recipients to obtain a certificate for use in communications via a CBRS communications band of the network 104. Upon establishing the communications via the non-CBRS communication band, the user device 102 can connect to a CBRS certificate service 114, which can be executed and/or hosted by a device such as the server computer 116. Because the CBRS certificate service 114 can be hosted and/or executed by additional and/or alternative devices and/or resources (e.g., in a cloud computing environment, or the like), it should be understood that this example is illustrative, and therefore should not be construed as being limiting in any way.

According to various embodiments, the functionality of the server computer 116 may be provided by one or more server computers, application servers, desktop computers, other computing systems, and the like. The functionality of the server computer 116 may be provided by a single device, by two or more similar devices, and/or by two or more dissimilar devices. For purposes of describing the concepts and technologies disclosed herein, the server computer 116 is described herein as a server computer such as a web server or application server that can be accessible via the network 104 such as the Internet or other networks (e.g., via the non-CBRS communication band or other channels). It should be understood that this embodiment is illustrative, and therefore should not be construed as being limiting in any way.

According to various embodiments of the concepts and technologies disclosed herein, the CBRS certificate request 112 can be sent to request, from the CBRS certificate service 114, a CBRS certificate 118 for installation at the user device 102 and for use during communications by the user device 102 via a CBRS communication band of the network 104. The CBRS certificate request 112 can correspond to an instruction, command, request, or other data for indicating, to the recipient such as the CBRS certificate service 114, that the user device 102 needs a CBRS certificate 118. As will be explained in more detail herein, the CBRS certificate service 114 can be configured to receive the CBRS certificate request 112 and to perform various functions to provide the CBRS certificate 118 to the user device 102 in response to the CBRS certificate request 112 and/or other communications. It should be understood that this example is illustrative, and therefore should not be construed as being limiting in any way.

In particular, the CBRS certificate service 114 can be configured to receive the CBRS certificate request 112. In response to receiving the CBRS certificate request 112, the CBRS certificate service 114 can perform operations to authenticate the requestor associated with the CBRS certificate request 112 (e.g., the user device 102). According to various embodiments of the concepts and technologies disclosed herein, the CBRS certificate service 114 can challenge the user device 102 for a use name and password, a token, and/or other authentication credentials. According to various embodiments of the concepts and technologies disclosed herein, the user device 102 can be configured (e.g., via execution of the CBRS application 108) to retrieve the CBRS credentials 110 from the secure memory of the user device 102 to provide to the CBRS certificate service 114 in response to the challenge. It should be understood that this example is illustrative, and therefore should not be construed as being limiting in any way.

The CBRS credentials 110 can include a login, a password, a private key, a public key, a token, or the like, any and/or all of which can be authenticated by the CBRS certificate service 114 to determine whether or not to act on the CBRS certificate request 112. According to various embodiments of the concepts and technologies disclosed herein, one or more, or all, of the CBRS credentials 110, for example a login, password, private key, public key, token, or the like, can be stored by a device manufacturer in a secure memory of the user device 102 prior to shipping the user device 102. The device manufacturer also can provide the public key, the private key, the login, the token, and/or other credentials to various entities such as, for example, the server computer 116, the CBRS certificate hosting server 120, or other devices and/or entities for use in authenticating the user device 102. If the user device 102 is not properly authenticated by the CBRS credentials 110, the CBRS certificate service 114 can end the session with the user device 102 and/or deny the request for the CBRS certificate 118. It should be understood that this example is illustrative, and therefore should not be construed as being limiting in any way.

If the user device 102 is properly authenticated by the CBRS certificate service 114, the CBRS certificate service 114 can perform various operations for providing the CBRS certificate 118 to the user device 102. In various embodiments of the concepts and technologies disclosed herein, the CBRS certificate service 114 can be configured to allow the user device 102 to log into the CBRS certificate service 114. According to various embodiments of the concepts and technologies disclosed herein, the server computer 116 can communicate with a CBRS certificate hosting server 120 via the network 104, a direct connection, and/or other functionality. According to various embodiments of the concepts and technologies disclosed herein, the CBRS certificate hosting server 120 can correspond to a certificate authority and/or certificate issuing authority. It should be understood that this example is illustrative, and therefore should not be construed as being limiting in any way.

According to various embodiments, the functionality of the CBRS certificate hosting server 120 may be provided by one or more server computers, application servers, desktop computers, other computing systems, and the like. The functionality of the CBRS certificate hosting server 120 may be provided by a single device, by two or more similar devices, and/or by two or more dissimilar devices. For purposes of describing the concepts and technologies disclosed herein, the CBRS certificate hosting server 120 is described herein as a server computer such as a web server or application server that can be accessible via a direct connection with the server computer 116 and/or via one or more networking connections (e.g., via part of the network 104). It should be understood that this embodiment is illustrative, and therefore should not be construed as being limiting in any way.

According to various embodiments, the CBRS certificate hosting server 120 can expose an application programming interface (“API”) 122 that can be made accessible, by the CBRS certificate hosting server 120 to authorized users such as, for example, the server computer 116 and/or an authorized device connected to the CBRS certificate hosting server 120 (e.g., a properly authenticated user device 102 as illustrated and described above). It should be understood that this example is illustrative, and therefore should not be construed as being limiting in any way.

Thus, according to various embodiments of the concepts and technologies disclosed herein, the user device 102 can effectively connect to the API 122 via the server computer 116 using REST or other technologies. Thus, for example, in some embodiments the user device 102 can access, via the server computer 116, the CBRS certificate hosting server 120 via one or more RESTful API calls, which can be generated via the server computer 116. As such, the user device 102 can, as a registered and authenticated user of the CBRS certificate service 114, effectively communicate with the CBRS certificate hosting server 120 to take one or more operations for obtaining the CBRS certificate 118 from the CBRS certificate hosting server 120. It should be understood that this example is illustrative, and therefore should not be construed as being limiting in any way.

According to various embodiments of the concepts and technologies disclosed herein, the user device 102 can communicate with the CBRS certificate hosting server 120 (via one or more API calls via the server computer 116) to create a private key and a certificate signing request (“CSR”). In some embodiments of the concepts and technologies disclosed herein, the user device 102 can call the CBRS certificate service 114 via an API 122 exposed by the server computer 116 to create the private key and/or to create the certificate signing request, whereby the server computer 116 can be configured to connect the API calls to the CBRS certificate hosting server 120 via RESTful API calls as noted herein. It should be understood that this example is illustrative, and therefore should not be construed as being limiting in any way.

According to various embodiments, the CBRS certificate hosting server 120 can be configured to verify the possession of the private key by the user device 102 to ensure that the user device 102 is entitled to receive the CBRS certificate 118. In some embodiments, the CBRS certificate request 112 received at the server computer 116 can include a certificate signing request that can be signed by the user device 102 using a private key (which is illustrated in FIG. 1 as part of the CBRS credentials 110). Thus, it should be understood that the CBRS credentials 110 can be provided to the server computer 116 by the user device 102 by signing the certificate signing request (e.g., the CBRS certificate request 112) using the private key. It should be understood that this example is illustrative, and therefore should not be construed as being limiting in any way.

The CBRS certificate hosting server 120 can be configured to determine whether or not the user device 102 is in possession of the appropriate private key by examining the digital signature on the certificate signing request. If the user device 102 is again properly authenticated (it can be appreciated that the user device 102 first authenticates with the server computer 116 and then is again authenticated by the CBRS certificate hosting server 120), the CBRS certificate hosting server 120 can be configured to issue a CBRS certificate 118 for use by the user device 102. According to various embodiments of the concepts and technologies disclosed herein, the CBRS certificate hosting server 120 can be configured to provide the CBRS certificate 118 to the server computer 116, and the server computer 116 can be configured to provide the CBRS certificate 118 to the user device 102.

Upon receiving the CBRS certificate 118, the user device 102 can be configured (e.g., via execution of the CBRS application 108), to store the CBRS certificate 118 at the user device 102. According to some embodiments of the concepts and technologies disclosed herein, the user device 102 can be configured (e.g., via execution of the CBRS application 108) to store the CBRS certificate 118 in the secure memory, in some embodiments, though this is not necessarily the case. Thus, the user device 102 can obtain the CBRS certificate 118 over-the-air via a wireless connection with the server computer 116 (e.g., via the non-CBRS communication band of the network 104). It should be understood that this example is illustrative, and therefore should not be construed as being limiting in any way.

The user device 102 can be configured (e.g., via execution of the CBRS application 108) to scan for a CBRS communication band. Upon discovering a CBRS communication band, the user device 102 can be configured to install the CBRS certificate 118 for future use. In some embodiments, the user device 102 can be configured to communicate via the CBRS communication band with one or more other devices such as, for example, a computing device 124 such as a mobile telephone, an Internet-of-things device, a gateway, other devices, combinations thereof, or the like.

In practice, a user device 102 can be configured, for example by a manufacturer or other entity, to obtain and install a CBRS certificate 118 at any time (e.g., after shipping to an end customer, after activation by an end customer, during a setup process by an installation technician, at other times, or the like). According to various embodiments of the concepts and technologies disclosed herein, the user device 102 can be configured to support a trusted execution environment, for example, by a processor, a component or portion of a processor, and/or by other hardware and/or software. The user device 102 can be configured to execute, in the trusted execution environment, a CBRS application 108 for obtaining and installing the CBRS certificate 118. It should be understood that this example is illustrative, and therefore should not be construed as being limiting in any way.

In particular, the user device 102 can be configured, e.g., via execution of the CBRS application 108, to communicate with a CBRS certificate service 114 to obtain the CBRS certificate 118. According to various embodiments of the concepts and technologies disclosed herein, the user device 102 can store CBRS credentials 110 in a secure memory. The CBRS credentials 110 can include, for example, a private key, a login, a password, a token, and/or other credentials that can be used to obtain the CBRS certificate 118 as illustrated and described herein. The secure memory, as generally is known, can protect the private key, login, password, token, and/or other credentials from unauthorized access (e.g., if the user device 102 is improperly obtained and analyzed, these and other data may be inaccessible to the unauthorized entity). Similarly, by not shipping the user device 102 with the CBRS certificate 118, the CBRS certificate 118 can be protected from unauthorized access, among other benefits. It should be understood that this example is illustrative, and therefore should not be construed as being limiting in any way.

The user device 102 can be configured, e.g., via execution of the CBRS application 108, to detect a powering on of the user device 102 (e.g., at a first use of the user device 102, during a setup of the user device 102, and/or at other times). In response to detecting the powering on of the user device 102, the CBRS application 108 can cause the user device 102 to scan for a non-CBRS communication band such as an LTE connection, a 5G connection, or the like. Upon identification of the non-CBRS communication band, the user device 102 can be configured to register with the non-CBRS communication band to enable communications with the server computer 116 and/or other entities.

The user device 102 can be configured to authenticate with the CBRS certificate service 114 and/or the server computer 116. In some embodiments, for example, the user device 102 can provide a username and/or password to the server computer 116 for authentication. In some other embodiments, the user device 102 may provide a token and/or other data to authenticate with the server computer 116. Once the user device 102 has been authenticated by the server computer 116, the user device 102 can communicate with the server computer 116 and/or with the CBRS certificate hosting server 120 to obtain a CBRS certificate 118.

In some embodiments, the user device 102 can communicate with the server computer 116 via a portal, API 122, or other functionality that can be exposed by the server computer 116. The server computer 116 also can be configured to support RESTful API calls, by which the user device 102 can effectively communicate with the CBRS certificate hosting server 120 via one or more API calls. In particular, the user device 102 can communicate with the CBRS certificate hosting server 120 to create a certificate signing request. This certificate signing request can be signed with a private key (e.g., a private key that can be stored in the secure memory of the user device 102 and/or that can be obtained by the user device 102 via communications with the server computer 116 and/or the CBRS certificate hosting server 120). The CBRS certificate hosting server 120 can be configured to determine if the private key used to sign the certificate signing request is signed with the appropriate private key. If so, the CBRS certificate hosting server 120 can be configured to issue the CBRS certificate 118 for use by the user device 102.

In some embodiments, the CBRS certificate hosting server 120 can be configured to issue the CBRS certificate 118 to the server computer 116, and the server computer 116 can forward the CBRS certificate 118 to the user device 102 (e.g., via the API 122, portal, etc.). The user device 102 can perform operations (e.g., by executing the CBRS application 108, via instructions from an installation technician, etc.) to connect to the CBRS communication band of the network 104 and to install the CBRS certificate 118 at the user device 102. In some embodiments, the CBRS certificate 118 can be stored in the secure memory, though this is not necessarily the case in all embodiments. The user device 102 can connect to one or more computing devices 124 (e.g., an Internet-of-things device, a gateway, a computer, etc.) via the CBRS communication band, and can be authorized for CBRS communications using the CBRS certificate 118. It should be understood that this example is illustrative, and therefore should not be construed as being limiting in any way.

FIG. 1 illustrates one user device 102, one network 104 (supporting or providing one non-CBRS communication band and one CBRS communication band), one server computer 116, and one CBRS certificate hosting server 120. It should be understood, however, that various implementations of the operating environment 100 can include one or more than one user device 102; one or more than one network 104 (supporting or providing one or more than one non-CBRS communication band and one or more than one CBRS communication band); one or more than one server computer 116; and/or one or more than one CBRS certificate hosting server 120. As such, the illustrated embodiment should be understood as being illustrative, and therefore should not be construed as being limiting in any way.

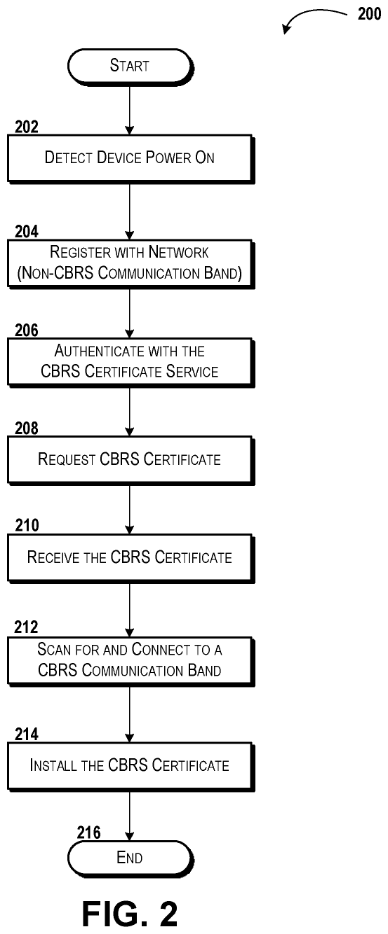

Turning now to FIG. 2, aspects of a method 200 for installing a CBRS certificate 118 at a user device 102 will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the user device 102 or the server computer 116, to perform one or more operations and/or causing the processor to direct other components of the computing system or device to perform one or more of the operations.

For purposes of illustrating and describing the concepts of the present disclosure, the method 200 is described herein as being performed by the user device 102 via execution of one or more software modules such as, for example, the CBRS application 108. It should be understood that additional and/or alternative devices and/or network nodes can provide the functionality described herein via execution of one or more modules, applications, and/or other software including, but not limited to, the CBRS application 108. Thus, the illustrated embodiments are illustrative, and should not be viewed as being limiting in any way.

The method 200 begins at operation 202. At operation 202, the user device 102 can detect a powering on of the user device 102. According to various embodiments of the concepts and technologies disclosed herein, the user device 102 can be configured, e.g., via execution of the CBRS application 108, to detect the powering on of the user device 102. For example, the CBRS application 108 can be configured to execute during a first startup of the user device 102, during initialization of the user device 102, during a first attachment to a network such as the network 104, and/or at other times.

In some embodiments, operation 202 can correspond to the user device 102 detecting a first powering on of the user device 102, though this is not necessarily the case in all embodiments. In some other embodiments, the user device 102 can be configured to detect each powering on of the user device 102 if a CBRS certificate 118 is not stored in a memory of the user device 102 or in a secured memory of the user device 102. It should be understood that in some embodiments, operation 202 can be omitted and the functionality illustrated and described herein with reference to FIG. 2 can be performed in response to receiving a command to install a CBRS certificate 118 (e.g., via an installer, via a setup application, via entry of a field code at the user device 102, via other commands or operations, combinations thereof, or the like). As such, it should be understood that this example is illustrative, and therefore should not be construed as being limiting in any way.

From operation 202, the method 200 can proceed to operation 204. At operation 204, the user device 102 can register with the network 104. According to various embodiments of the concepts and technologies disclosed herein, operation 204 can correspond to the user device 102 scanning (e.g., using a radio transceiver such as a cellular transceiver, a WIFI® transceiver, a BLUETOOTH® transceiver, or the like) for an available radio network connection.

According to various embodiments of the concepts and technologies disclosed herein, operation 204 can correspond to the user device 102 scanning for and identifying a non-CBRS communication band such as, for example, a cellular network connection (e.g., a 2G, 3G, 4G, or 5G cellular network connection), a WIFI® network connection, a BLUETOOTH® connection, other connections, combinations thereof, or the like. Upon identifying the non-CBRS communication band, the user device 102 can connect to the network 104 via the non-CBRS communication band and register with the network 104.

As is generally understood, operation 204 therefore can correspond to the user device 102 identifying and attaching to a non-CBRS communication band of the network 104. According to various embodiments, the non-CBRS communication band of the network 104 can support data communications for the user device 102. It should be understood that this example is illustrative, and therefore should not be construed as being limiting in any way.

From operation 204, the method 200 can proceed to operation 206. At operation 206, the user device 102 can authenticate with the CBRS certificate service 114. In particular, operation 206 can correspond to the user device 102 connecting to the server computer 116 and/or the CBRS certificate service 114 hosted thereby and attempting to login and/or access the CBRS certificate service 114. In some embodiments, for example, the user device 102 can be provisioned with one or more CBRS credentials 110 such as, for example, a login and password for the CBRS certificate service 114, a token for logging into the CBRS certificate service 114, a private key for use in communicating with the CBRS certificate service 114, combinations thereof, or the like.

Thus, operation 206 can correspond to the user device 102 connecting to the server computer 116 and/or the CBRS certificate service 114 hosted thereby and providing its login credentials such as, for example, a login and password. According to various embodiments, as illustrated and described in FIG. 1, the user device 102 can retrieve the login and password or other login credentials from a secure memory and/or trusted execution environment of the user device 102. Because other methods of authenticating with the CBRS certificate service 114 are possible and are contemplated, and because credentials for the user device 102 can be stored in additional and/or alternative locations, it should be understood that these examples are illustrative, and therefore should not be construed as being limiting in any way.

From operation 206, the method 200 can proceed to operation 208. At operation 208, the user device 102 can request a CBRS certificate 118. In particular, operation 208 can include the user device 102 creating a certificate signing request or other request for a CBRS certificate 118. Additionally, operation 208 can include the user device 102 signing the certificate signing request using a private key. As noted above, the private key can be provisioned at any time including, but not limited to, device manufacturing, device flashing or OS installation, shipping, and/or via negotiations with the CBRS certificate service 114 and/or the CBRS certificate hosting server 120 as illustrated and described herein. In some embodiments, the private key can be included in the CBRS credentials 110 and stored in a memory, a secure memory, and/or in another data storage location at or accessible to the user device 102. It should be understood that this example is illustrative, and therefore should not be construed as being limiting in any way.

Operation 208 also can include the user device 102 submitting the certificate signing request to the CBRS certificate service 114. As noted above, the certificate signing request can be signed by the user device 102 using the private key. The user device 102 can submit the signed request to the CBRS certificate service 114 via an API 122, portal, and/or other functionality exposed by the server computer 116, in some embodiments. According to various embodiments of the concepts and technologies disclosed herein, the server computer 116 can then request a CBRS certificate 118 from the CBRS certificate hosting server 120 by way of the API 122 exposed by the CBRS certificate hosting server 120. In some embodiments, the user device 102 and/or the server computer 116 can enable RESTful API calls, by which the properly authenticated user device 102 can effectively request (via the server computer 116) the CBRS certificate 118. It should be understood that this example is illustrative, and therefore should not be construed as being limiting in any way.

From operation 208, the method 200 can proceed to operation 210. At operation 210, the user device 102 can receive the CBRS certificate 118 from the server computer 116. As explained herein, the CBRS certificate 118 can be received by the user device 102 from the server computer 116. In some embodiments, the CBRS certificate hosting server 120 can be configured to route the delivery of the CBRS certificate 118 through the server computer 116, for example, via the API 122 or portal or other functionality via which the API call or command was received to request the CBRS certificate 118.

In some other embodiments, the CBRS certificate hosting server 120 can deliver the CBRS certificate 118 to the server computer 116, and the server computer 116 can deliver the CBRS certificate 118 to the user device 102. According to various embodiments of the concepts and technologies disclosed herein, the CBRS certificate 118 can be delivered to the user device 102 via the non-CBRS communication channel, which can include a secure (e.g., encrypted) wireless data connection. Thus, embodiments of the concepts and technologies disclosed herein can effect delivery of the CBRS certificate 118 to the user device 102 outside of a CBRS communication channel and/or a CBRS environment, which is a new approach to installing the CBRS certificate 118.

Although not separately shown in FIG. 2, the user device 102 can be configured to store the CBRS certificate 118. In some embodiments, the user device 102 can store the CBRS certificate 118 in a secure memory of the user device 102, or in another data storage location that is located at and/or accessible to the user device 102. It should be understood that this example is illustrative, and therefore should not be construed as being limiting in any way.

From operation 210, the method 200 can proceed to operation 212. At operation 212, the user device 102 can scan for and connect to a CBRS communication band of the network 104. According to various embodiments of the concepts and technologies disclosed herein, the user device 102 can be configured to recognize a particular communication channel or band as corresponding to a CBRS communication band, so operation 212 can correspond to the user device 102 scanning for communication channels and determining, based on the identified communication channels, which of the identified communication channels correspond to the CBRS communication band.

The user device 102 can connect to the CBRS communication band identified in the scan, in some embodiments, or the user device 102 can connect to one of multiple CBRS communication bands identified in the scan, if more than one CBRS communication band is identified. It can be appreciated that the user device 102 can be configured to search for a particular channel or band, so the “scan” illustrated and described herein may correspond to searching available channels to identify the specified CBRS communication band. Because the CBRS communication band can be identified in additional and/or alternative manners, it should be understood that these examples are illustrative, and therefore should not be construed as being limiting in any way.

From operation 212, the method 200 can proceed to operation 214. At operation 214, the user device 102 can install the CBRS certificate 118 for use by the user device 102 for communications via the CBRS communication band of the network 104. Thus, for example, when the user device 102 attempts to connect to another device via the CBRS communication band (e.g., the computing device 124 shown in FIG. 1), the CBRS certificate 118 can be used by the user device 102 to authenticate these communications. It can be appreciated that the CBRS certificate 118 can be stored in the secure memory of the user device 102, if desired. It should be understood that this example is illustrative, and therefore should not be construed as being limiting in any way.

From operation 214, the method 200 can proceed to operation 216. The method 200 can end at operation 216.

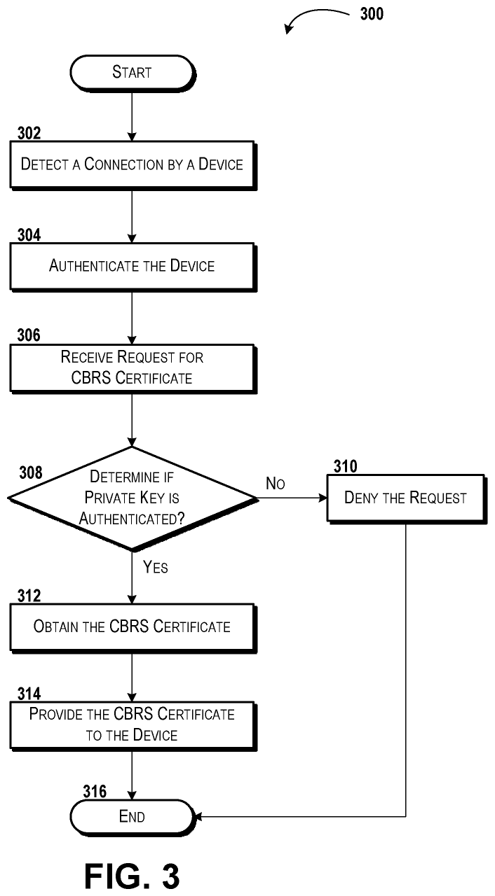

Turning now to FIG. 3, aspects of a method 300 for providing a CBRS certificate 118 to a user device 102 for installation will be described in detail, according to an illustrative embodiment. For purposes of illustrating and describing the concepts of the present disclosure, the method 300 is described herein as being performed by the server computer 116 via execution of one or more software modules such as, for example, the CBRS certificate service 114. It should be understood that additional and/or alternative devices and/or network nodes can provide the functionality described herein via execution of one or more modules, applications, and/or other software including, but not limited to, the CBRS certificate service 114. Thus, the illustrated embodiments are illustrative, and should not be viewed as being limiting in any way.

The method 300 begins at operation 302. At operation 302, the server computer 116 can detect a connection from the user device 102. As explained herein with reference to FIG. 1, the connection with the server computer 116 detected in operation 302 can occur via the non-CBRS communication band of the network 104, in some embodiments. The user device 102 can connect to the server computer 116 for the purpose of obtaining a CBRS certificate 118, as explained herein. It should be understood that this example is illustrative, and therefore should not be construed as being limiting in any way.

In some embodiments of the concepts and technologies disclosed herein, operation 302 can include the server computer 116 receiving a CBRS certificate request 112 from a device such as the user device 102. Thus, for example, “detecting a connection” of the user device 102 can correspond to receiving the CBRS certificate request 112 and determining, based on receiving the CBRS certificate request 112, that the user device 102 has connected to the server computer 116. In some other embodiments, the server computer 116 can perform the functionality of operation 302 by way of detecting a login attempt, for example via a portal, API 122, or other functionality that can be exposed by the server computer 116. As such, it should be understood that operation 302 can include the server computer 116 detecting a connection by the user device 102 and/or other communications that can indicate that the user device 102 has connected or is trying to connect to the server computer 116. It should be understood that these examples are illustrative, and therefore should not be construed as being limiting in any way.

From operation 302, the method 300 can proceed to operation 304. At operation 304, the server computer 116 can authenticate the device that connected to the server computer 116 in operation 302. Thus, for example, operation 304 can correspond to the server computer 116 authenticating the user device 102. According to various embodiments of the concepts and technologies disclosed herein, operation 304 can correspond to the user device 102 exchanging login credentials with the server computer 116, for example, by providing a login and/or password for accessing the server computer 116 via a portal, API 122, or the like.

In some other embodiments, the user device 102 can be provisioned with a token or other authentication functionality, and operation 304 can correspond to the user device 102 providing the token to the server computer 116 and/or the server computer 116 receiving the token from the user device 102. Because the user device 102 or other device can be authenticated by the server computer 116 in additional and/or alternative manners, it should be understood that these examples are illustrative, and therefore should not be construed as being limiting in any way.

From operation 304, the method 300 can proceed to operation 306. At operation 306, the server computer 116 can receive a request for a CBRS certificate 118. According to various embodiments of the concepts and technologies disclosed herein, the server computer 116 can perform the functionality of operation 306 by way of detecting a command, selection, API call, or the like, via the portal, API 122, or other functionality exposed by the server computer 116.

In some embodiments, for example, the server computer 116 can expose an API 122 to the user device 102, and the user device 102 can create, via the API 122, a RESTful API call for the CBRS certificate 118. The server computer 116 can be configured to connect the user device 102 to the CBRS certificate hosting server 120 via an API 122 that can be exposed by the CBRS certificate hosting server 120. In some other embodiments, the server computer 116 can directly request the CBRS certificate 118 from the CBRS certificate hosting server 120 based on information provided by the user device 102 such as, for example, a certificate signing request from the user device 102, where the certificate signing request can be signed by the user device 102 using a private key.

As explained above, the private key can be stored by the user device 102 in a secure memory and may be provisioned, in some embodiments, by a device manufacturer or other authorized entity for use in the obtaining of the CBRS certificate 118 as illustrated and described herein. Because the request for the CBRS certificate 118 can be made in additional and/or alternative manners, it should be understood that these examples are illustrative, and therefore should not be construed as being limiting in any way.

From operation 306, the method 300 can proceed to operation 308. At operation 308, the server computer 116 can determine if the private key used to sign the certificate signing request received in operation 306 is authenticated. Thus, operation 308 can include the server computer 116 determining if the user device 102 is in possession of an authorized private key. More particularly, since the device manufacturer that stores the private key in the user device 102 can share a copy of the private key with the server computer 116, the server computer 116 can determine if the private key used to sign the signed certificate signing request matches the known private key (e.g., a copy of the private key stored by the server computer 116) for the user device 102. It should be understood that this example is illustrative, and therefore should not be construed as being limiting in any way.

Thus, it can be appreciated that according to various embodiments of the concepts and technologies disclosed herein, the user device 102 can be provisioned with a private key at some time (e.g., at manufacturing time, when sent to a customer, when powered on for installation of the CBRS certificate 118, via negotiations with the CBRS certificate service 114 and/or other entities such as the CBRS certificate hosting server 120, at other times, or the like). The CBRS certificate service 114 can be made aware of the private key, in some embodiments, and/or the CBRS certificate service 114 can communicate with the CBRS certificate hosting server 120, which can be aware of the private key.

Thus, in some embodiments of the concepts and technologies disclosed herein, operation 308 can include the server computer 116 (via execution of the CBRS certificate service 114) determining if the private key is or is not valid. In some other embodiments of the concepts and technologies disclosed herein, operation 308 can include the server computer 116 (via execution of the CBRS certificate service 114) communicating with the CBRS certificate hosting server 120 to determine if the private key is or is not valid. Because the private key used to sign the certificate signing request can be determined to be authenticated or not authenticated in additional and/or alternative manners, it should be understood that these examples are illustrative, and therefore should not be construed as being limiting in any way.

If the server computer 116 determines, in operation 308, that the private key used to sign the certificate signing request is not authenticated, the method 300 can proceed to operation 310. At operation 310, the server computer 116 can deny the request for the CBRS certificate 118 received in operation 306. Thus, operation 308 can also include the server computer 116 declining to authenticate the user or user device 102 that provided the request for the CBRS certificate 118 in operation 306 (e.g., the user device 102).

In some other embodiments, operation 310 also can include the server computer 116 revoking access to the CBRS certificate service 114 based on the determination that the private key used to sign the certificate signing request received in operation 306 is invalid—thereby revoking the authentication of the user device 102 that occurred in operation 304. In some other embodiments, the previous authentication of operation 304 is not revoked by the server computer 116 in operation 310, so it should be understood that this example is illustrative, and therefore should not be construed as being limiting in any way.

If the server computer 116 determines, in operation 308, that the private key used to sign the certificate signing request is authenticated, the method 300 can proceed to operation 312. At operation 312, the server computer 116 can obtain the CBRS certificate 118 from the CBRS certificate hosting server 120. Thus, operation 312 can also include the server computer 116 authenticating the certificate signing request received in operation 306, and requesting the CBRS certificate 118 from the CBRS certificate hosting server 120.

In some embodiments, the server computer 116 can request the CBRS certificate 118 from the CBRS certificate hosting server 120 by passing the certificate signing request received in operation 306 to the CBRS certificate hosting server 120 (e.g., via a RESTful API call or the like). In some other embodiments, the server computer 116 can request the CBRS certificate 118 from the CBRS certificate hosting server 120 by creating a new request for the CBRS certificate 118, which the server computer 116 can send to the CBRS certificate hosting server 120 directly. Because the CBRS certificate 118 can be requested in operation 312 in additional and/or alternative manners, it should be understood that these examples are illustrative, and therefore should not be construed as being limiting in any way.

From operation 312, the method 300 can proceed to operation 314. At operation 308, the server computer 116 can provide the CBRS certificate 118 to the user device 102 associated with the request for the CBRS certificate 118 received in operation 306. According to various embodiments, the CBRS certificate 118 can be provided to the user device 102 via the portal, API 122, or other functionality via which the user device 102 connects to the CBRS certificate service 114 and the server computer 116; by sending the CBRS certificate 118 via a data session; and/or by otherwise providing the CBRS certificate 118 to the user device 102. In yet other embodiments, the server computer 116 can transmit a download link or other reference to the user device 102, and the user device 102 can access the CBRS certificate 118 via the link provided. Because the CBRS certificate 118 can be provided to the user device 102 in additional and/or alternative manners, it should be understood that these examples are illustrative, and therefore should not be construed as being limiting in any way.

From operation 314, the method 300 can proceed to operation 316. The method 300 also can proceed to operation 316 from operation 310. The method 300 can end at operation 316.

The following additional features can be included in any of the embodiments of the concepts and technologies disclosed herein. According to various embodiments of the concepts and technologies disclosed herein, the network 104 can comply with particular requirements to provide the functionality illustrated and described herein. For example, the network 104 can be required to support the CBRS communication band (e.g., LTE band 48), and at least one other LTE band. Additionally, according to various embodiments of the concepts and technologies disclosed herein, the network 104 may be required to have a selected CBRS root certified authority operator that is certified by WlnnForum, and to have a business agreement with the certificate authority.

Thus, the CBRS certificate hosting server 120 illustrated and described herein can include a selected CBRS root certificate authority that is certified by WlnnForum. Under such arrangements, the number of CBRS certificates 118 purchased by the network 104 and/or other service providers and/or subscribers such as the device manufacturer may be required to be fixed and agreed upon. It should be understood that this example embodiment and the associated example requirements for the network 104 are illustrative of one contemplated embodiment and therefore should not be construed as being limiting in any way.

According to various embodiments of the concepts and technologies disclosed herein, the user device 102 illustrated and described herein can also have various requirements that may be imposed thereon to provide the functionality illustrated and described herein. For example, the user device 102 can include a CBSD Category A or B subscriber device, and for that device, the digital certificate subscriber agreement form must be completed by the subscriber (e.g., the device manufacturer) and approved by the CBRS root certified authority operator. It should be understood that this example is illustrative, and therefore should not be construed as being limiting in any way.

Furthermore, other than the CBRS communication band (e.g., LTE band 48), the user device 102 may be required to support one additional LTE band offered by the same service provider (e.g., the network 104). Furthermore, the user device 102 can be required in some embodiments to carry an embedded Linux® OS application such as the CBRS application 108 illustrated and described herein for communicating with the CBRS root certified authority operator server using the non-CBRS communication band and for downloading the CBRS certificate 118. It should be understood that this example is illustrative, and therefore should not be construed as being limiting in any way.

In some embodiments of the concepts and technologies disclosed herein, the username and password for accessing the CBRS root certified authority operator server (e.g., the CBRS certificate hosting server 120) can be stored in an encrypted format in a secure and reserved memory location on the user device 102, for example, the secure memory of the user device 102 as illustrated and described herein. Furthermore, the user device 102 can use a hardware security element (“SE”) or a trusted execution environment for the application and/or other data used to install the CBRS certificate 118. This can further secure the software on the user device 102 as well as the further securing the stored username and password.

According to various embodiments of the concepts and technologies disclosed herein, the CBRS application 108 can include an embedded Linux OS application that can be secured as a part of the software of the user device 102. Thus, confidentiality and integrity of the CBRS application 108 can be preserved by appropriate industry-standard security measures, in various embodiments. Furthermore, the CBRS application 108 can be configured to use the username and password for connecting to the CBRS root certified authority operator's server (e.g., the CBRS certificate hosting server 120). Also, the CBRS application 108 can be configured to retrieve the username and password stored in an encrypted format in a secure memory location on the user device 102, and can be configured to protect the stored username and password against memory-corruption vulnerabilities (e.g., buffer overflows, stack overflow, heap overflow). Thus, the CBRS application 108 can be configured to reject untrusted/insecure external inputs and passes to its software architecture and functions. It should be understood that these examples are illustrative, and therefore should not be construed as being limiting in any way.

According to various embodiments of the concepts and technologies disclosed herein, the embedded Linux® application (e.g., the CBRS application 108) can be signed by the subscriber (e.g., the device manufacturer). In particular, in some embodiments the application signing can begin by generating a private and public key pair and a related public-key certificate. If code signing is used, the system can be configured to only allow the execution of code from signed application packages and/or services. The application or code signing can include a process of digitally signing a given application using a private key to identify the code's author (or company alias), to detect if the application has changed, and/or to establish trust between applications. It should be understood that this example is illustrative, and therefore should not be construed as being limiting in any way.

In some embodiments of the concepts and technologies disclosed herein, using the trusted execution environment to store the username and password in memory (e.g., the secure memory) of the user device 102 can include launching a protected memory partition that can be launched by the OS 106 of the user device 102 and/or the embedded Linux® application (e.g., the CBRS application 108). In a trusted execution environment, memory spaces can be reserved and allocated for the protected partition and marked protected, for example when a memory domain manager is loaded into the designated memory spaces and registered by an authenticated code module. It should be understood that this example is illustrative, and therefore should not be construed as being limiting in any way.

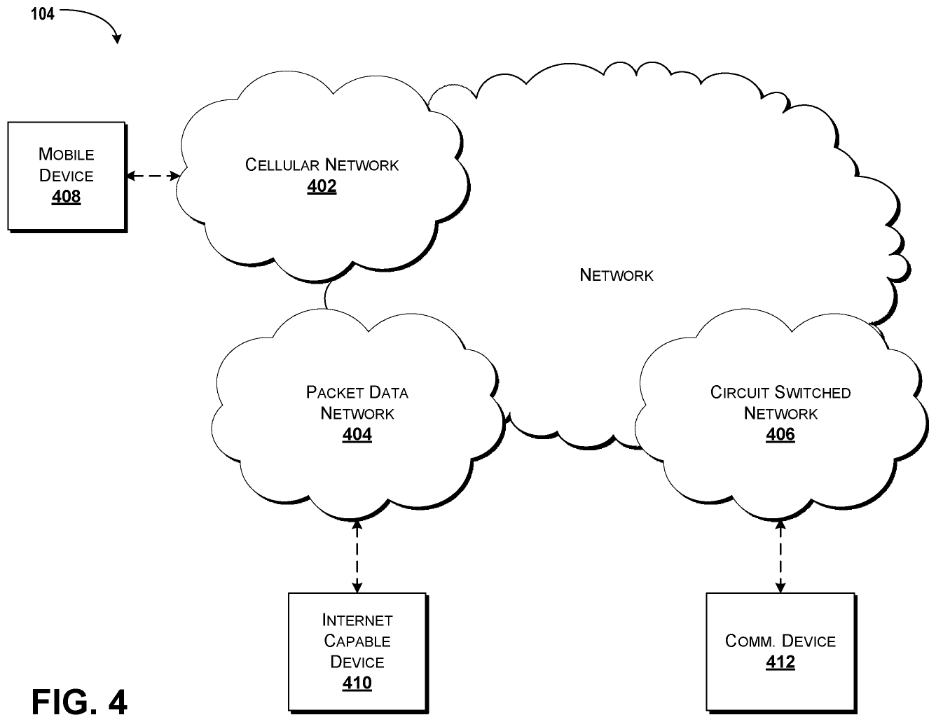

Turning now to FIG. 4, additional details of the network 104 are illustrated, according to an illustrative embodiment. The network 104 includes a cellular network 402, a packet data network 404, for example, the Internet, and a circuit switched network 406, for example, a publicly switched telephone network (“PSTN”). The cellular network 402 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 402 also includes radios and nodes for receiving and transmitting voice, data, and combinations thereof to and from radio transceivers, networks, the packet data network 404, and the circuit switched network 406.

A mobile communications device 408, such as, for example, a cellular telephone, a user equipment, a mobile terminal, a PDA, a laptop computer, a handheld computer, and combinations thereof, can be operatively connected to the cellular network 402. The cellular network 402 can be configured as a 2G GSM network and can provide data communications via GPRS and/or EDGE. Additionally, or alternatively, the cellular network 402 can be configured as a 3G UMTS network and can provide data communications via the HSPA protocol family, for example, HSDPA, EUL (also referred to as HSDPA), and HSPA+. The cellular network 402 also is compatible with 4G mobile communications standards, 5G mobile communications standards, other mobile communications standards, and evolved and future mobile communications standards.

The packet data network 404 includes various devices, for example, servers, computers, databases, and other devices in communication with one another, as is generally known. The packet data network 404 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 404 includes or is in communication with the Internet. The circuit switched network 406 includes various hardware and software for providing circuit switched communications. The circuit switched network 406 may include, or may be, what is often referred to as a plain old telephone system (POTS). The functionality of a circuit switched network 406 or other circuit-switched network are generally known and will not be described herein in detail.

The illustrated cellular network 402 is shown in communication with the packet data network 404 and a circuit switched network 406, though it should be appreciated that this is not necessarily the case. One or more Internet-capable devices 410, for example, a PC, a laptop, a portable device, or another suitable device, can communicate with one or more cellular networks 402, and devices connected thereto, through the packet data network 404. It also should be appreciated that the Internet-capable device 410 can communicate with the packet data network 404 through the circuit switched network 406, the cellular network 402, and/or via other networks (not illustrated).

As illustrated, a communications device 412, for example, a telephone, facsimile machine, modem, computer, or the like, can be in communication with the circuit switched network 406, and therethrough to the packet data network 404 and/or the cellular network 402. It should be appreciated that the communications device 412 can be an Internet-capable device, and can be substantially similar to the Internet-capable device 410. In the specification, the network 104 is used to refer broadly to any combination of the networks 402, 404, 406. It should be appreciated that substantially all of the functionality described with reference to the network 104 can be performed by the cellular network 402, the packet data network 404, and/or the circuit switched network 406, alone or in combination with other networks, network elements, and the like.

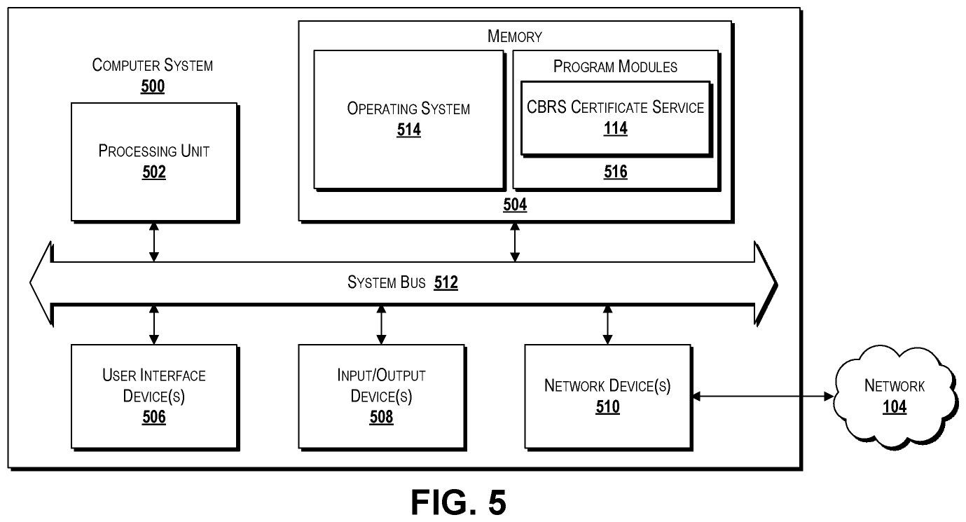

FIG. 5 is a block diagram illustrating a computer system 500 configured to provide the functionality described herein for over-the-air CBRS certificate installation, in accordance with various embodiments of the concepts and technologies disclosed herein. The computer system 500 includes a processing unit 502, a memory 504, one or more user interface devices 506, one or more input/output (“I/O”) devices 508, and one or more network devices 510, each of which is operatively connected to a system bus 512. The bus 512 enables bi-directional communication between the processing unit 502, the memory 504, the user interface devices 506, the I/O devices 508, and the network devices 510.

The processing unit 502 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 504 communicates with the processing unit 502 via the system bus 512. In some embodiments, the memory 504 is operatively connected to a memory controller (not shown) that enables communication with the processing unit 502 via the system bus 512. The memory 504 includes an operating system 514 and one or more program modules 516. The operating system 514 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or LEOPARD families of operating systems from APPLE CORPORATION, the FREEBSD family of operating systems, the SOLARIS family of operating systems from ORACLE CORPORATION, other operating systems, and the like.

The program modules 516 may include various software and/or program modules described herein. In some embodiments, for example, the program modules 516 can include the CBRS application 108, the CBRS certificate service 114, and/or other software. These and/or other programs can be embodied in computer-readable media containing instructions that, when executed by the processing unit 502, perform one or more of the methods 200 and 300 described in detail above with respect to FIGS. 2-3 and/or other functionality as illustrated and described herein. It can be appreciated that, at least by virtue of the instructions embodying the methods 200 and 300 and/or other functionality illustrated and described herein being stored in the memory 504 and/or accessed and/or executed by the processing unit 502, the computer system 500 is a special-purpose computing system that can facilitate providing the functionality illustrated and described herein. According to embodiments, the program modules 516 may be embodied in hardware, software, firmware, or any combination thereof. Although not shown in FIG. 5, it should be understood that the memory 504 also can be configured to store the CBRS credentials 110, the CBRS certificate request 112, the CBRS certificate 118, and/or other data, if desired.

By way of example, and not limitation, computer-readable media may include any available computer storage media or communication media that can be accessed by the computer system 500. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 500. In the claims, the phrase “computer storage medium” and variations thereof does not include waves or signals per se and/or communication media.

The user interface devices 506 may include one or more devices with which a user accesses the computer system 500. The user interface devices 506 may include, but are not limited to, computers, servers, personal digital assistants, cellular phones, or any suitable computing devices. The I/O devices 508 enable a user to interface with the program modules 516. In one embodiment, the I/O devices 508 are operatively connected to an I/O controller (not shown) that enables communication with the processing unit 502 via the system bus 512. The I/O devices 508 may include one or more input devices, such as, but not limited to, a keyboard, a mouse, or an electronic stylus. Further, the I/O devices 508 may include one or more output devices, such as, but not limited to, a display screen or a printer.

The network devices 510 enable the computer system 500 to communicate with other networks or remote systems via a network, such as the network 104. Examples of the network devices 510 include, but are not limited to, a modem, a radio frequency (“RF”) or infrared (“IR”) transceiver, a telephonic interface, a bridge, a router, or a network card. The network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

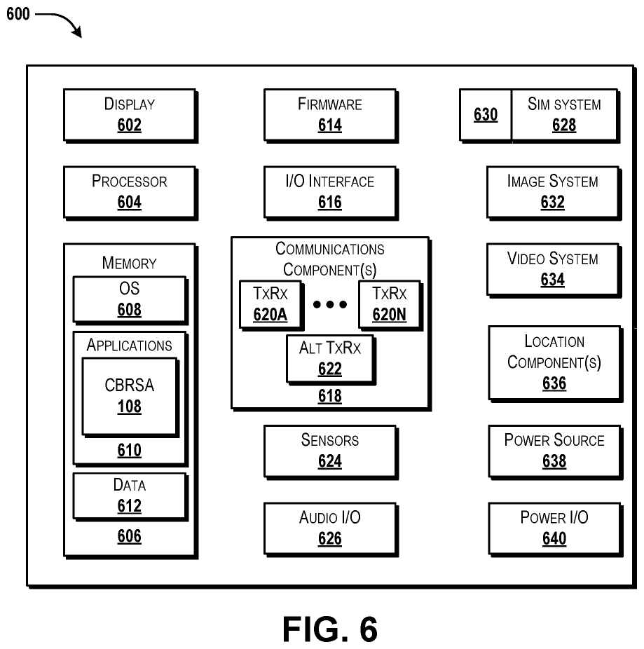

Turning now to FIG. 6, an illustrative mobile device 600 and components thereof will be described. In some embodiments, the user device 102 described above with reference to FIG. 1 can be configured as and/or can have an architecture similar or identical to the mobile device 600 described herein in FIG. 6. It should be understood, however, that the user device 102 may or may not include the functionality described herein with reference to FIG. 6. While connections are not shown between the various components illustrated in FIG. 6, it should be understood that some, none, or all of the components illustrated in FIG. 6 can be configured to interact with one another to carry out various device functions. In some embodiments, the components are arranged so as to communicate via one or more busses (not shown). Thus, it should be understood that FIG. 6 and the following description are intended to provide a general understanding of a suitable environment in which various aspects of embodiments can be implemented, and should not be construed as being limiting in any way.

As illustrated in FIG. 6, the mobile device 600 can include a display 602 for displaying data. According to various embodiments, the display 602 can be configured to display various graphical user interface (“GUI”) elements such as, for example, CBRS installation instructions, login and/or authentication screens, text, images, video, virtual keypads and/or keyboards, messaging data, notification messages, metadata, internet content, device status, time, date, calendar data, device preferences, map and location data, combinations thereof, and/or the like. The mobile device 600 also can include a processor 604 and a memory or other data storage device (“memory”) 606. The processor 604 can be configured to process data and/or can execute computer-executable instructions stored in the memory 606. Similarly, as explained herein above, a portion of the processor 604 can be dedicated in some embodiments to creating a trusted execution environment. Similarly, in some embodiments, a portion of the memory 606 or other data storage device can be configured to provide a secure memory. The computer-executable instructions executed by the processor 604 can include, for example, an operating system 608, one or more applications 610 such as the CBRS application 108, the CBRS certificate service 114, other computer-executable instructions stored in a memory 606, or the like. In some embodiments, the applications 610 also can include a UI application (not illustrated in FIG. 6).

The UI application can interface with the operating system 608, such as the operating system 106 shown in FIG. 1, to facilitate user interaction with functionality and/or data stored at the mobile device 600 and/or stored elsewhere. In some embodiments, the operating system 608 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 604 to aid a user in entering content, enter authentication information, obtain private keys, signing requests, configuring settings, manipulating address book content and/or settings, multimode interaction, interacting with other applications 610, and otherwise facilitating user interaction with the operating system 608, the applications 610, and/or other types or instances of data 612 that can be stored at the mobile device 600. The data 612 can include, for example, the CBRS application 108, the CBRS certificate service 114, an application for providing functionality of the CBRS certificate hosting server 120, and/or other applications or program modules. According to various embodiments, the data 612 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 610, the data 612, and/or portions thereof can be stored in the memory 606 and/or in a firmware 614, and can be executed by the processor 604.

It can be appreciated that, at least by virtue of storage of the instructions corresponding to the applications 610 and/or other instructions embodying other functionality illustrated and described herein in the memory 606, and/or by virtue of the instructions corresponding to the applications 610 and/or other instructions embodying other functionality illustrated and described herein being accessed and/or executed by the processor 604, the mobile device 600 is a special-purpose mobile device that can facilitate providing the functionality illustrated and described herein. The firmware 614 also can store code for execution during device power up and power down operations. It can be appreciated that the firmware 614 can be stored in a volatile or non-volatile data storage device including, but not limited to, the memory 606 and/or a portion thereof.

The mobile device 600 also can include an input/output (“I/O”) interface 616. The I/O interface 616 can be configured to support the input/output of data such as location information, CBRS credentials 110, the CBRS certificate request 112, the CBRS certificates 118, user information, organization information, presence status information, user IDs, passwords, and application initiation (start-up) requests. In some embodiments, the I/O interface 616 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45 or RJ48) port, a telephone (RJ11 or the like) port, a proprietary port, combinations thereof, or the like. In some embodiments, the mobile device 600 can be configured to synchronize with another device to transfer content to and/or from the mobile device 600. In some embodiments, the mobile device 600 can be configured to receive updates to one or more of the applications 610 via the I/O interface 616, though this is not necessarily the case. In some embodiments, the I/O interface 616 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 616 may be used for communications between the mobile device 600 and a network device or local device.

The mobile device 600 also can include a communications component 618. The communications component 618 can be configured to interface with the processor 604 to facilitate wired and/or wireless communications with one or more networks such as the network 104 described herein. In some embodiments, other networks include networks that utilize non-cellular wireless technologies such as WI-FI or WIMAX. In some embodiments, the communications component 618 includes a multimode communications subsystem for facilitating communications via the cellular network and one or more other networks.

The communications component 618, in some embodiments, includes one or more transceivers. The one or more transceivers, if included, can be configured to communicate over the same and/or different wireless technology standards with respect to one another. For example, in some embodiments one or more of the transceivers of the communications component 618 may be configured to communicate using GSM, CDMAONE, CDMA2000, LTE, and various other 2G, 2.5G, 3G, 4G, 5G, and greater generation technology standards. Moreover, the communications component 618 may facilitate communications over various channel access methods (which may or may not be used by the aforementioned standards) including, but not limited to, TDMA, FDMA, W-CDMA, OFDM, SDMA, and the like.

In addition, the communications component 618 may facilitate data communications using GPRS, EDGE, the HSPA protocol family including HSDPA, EUL or otherwise termed HSDPA, HSPA+, and various other current and future wireless data access standards. In the illustrated embodiment, the communications component 618 can include a first transceiver (“TxRx”) 620A that can operate in a first communications mode (e.g., GSM). The communications component 618 also can include an N^{th} transceiver (“TxRx”) 620N that can operate in a second communications mode relative to the first transceiver 620A (e.g., UMTS). While two transceivers 620A-N(hereinafter collectively and/or generically referred to as “transceivers 620”) are shown in FIG. 6, it should be appreciated that less than two, two, and/or more than two transceivers 620 can be included in the communications component 618.

The communications component 618 also can include an alternative transceiver (“Alt TxRx”) 622 for supporting other types and/or standards of communications. According to various contemplated embodiments, the alternative transceiver 622 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 618 also can facilitate reception from terrestrial radio networks, digital satellite radio networks, internet-based radio service networks, combinations thereof, and the like. The communications component 618 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 600 also can include one or more sensors 624. The sensors 624 can include temperature sensors, light sensors, air quality sensors, movement sensors, orientation sensors, noise sensors, proximity sensors, or the like. As such, it should be understood that the sensors 624 can include, but are not limited to, accelerometers, magnetometers, gyroscopes, infrared sensors, noise sensors, microphones, combinations thereof, or the like. Additionally, audio capabilities for the mobile device 600 may be provided by an audio I/O component 626. The audio I/O component 626 of the mobile device 600 can include one or more speakers for the output of audio signals, one or more microphones for the collection and/or input of audio signals, and/or other audio input and/or output devices.

The illustrated mobile device 600 also can include a subscriber identity module (“SIM”) system 628. The SIM system 628 can include a universal SIM (“USIM”), a universal integrated circuit card (“UICC”) and/or other identity devices. The SIM system 628 can include and/or can be connected to or inserted into an interface such as a slot interface 630. In some embodiments, the slot interface 630 can be configured to accept insertion of other identity cards or modules for accessing various types of networks. Additionally, or alternatively, the slot interface 630 can be configured to accept multiple subscriber identity cards. Because other devices and/or modules for identifying users and/or the mobile device 600 are contemplated, it should be understood that these embodiments are illustrative, and therefore should not be construed as being limiting in any way.

The mobile device 600 also can include an image capture and processing system 632 (“image system”). The image system 632 can be configured to capture or otherwise obtain photos, videos, and/or other visual information. As such, the image system 632 can include cameras, lenses, charge-coupled devices (“CCDs”), combinations thereof, or the like. The mobile device 600 may also include a video system 634. The video system 634 can be configured to capture, process, record, modify, and/or store video content. Photos and videos obtained using the image system 632 and the video system 634, respectively, may be added as message content to an MMS message, email message, and sent to another mobile device. The video and/or photo content also can be shared with other devices via various types of data transfers via wired and/or wireless communication devices as described herein.

The mobile device 600 also can include one or more location components 636. The location components 636 can be configured to send and/or receive signals to determine a geographic location of the mobile device 600. According to various embodiments, the location components 636 can send and/or receive signals from global positioning system (“GPS”) devices, assisted-GPS (“A-GPS”) devices, WI-FI/WIMAX and/or cellular network triangulation data, combinations thereof, and the like. The location component 636 also can be configured to communicate with the communications component 618 to retrieve triangulation data for determining a location of the mobile device 600. In some embodiments, the location component 636 can interface with cellular network nodes, telephone lines, satellites, location transmitters and/or beacons, wireless network transmitters and receivers, combinations thereof, and the like. In some embodiments, the location component 636 can include and/or can communicate with one or more of the sensors 624 such as a compass, an accelerometer, and/or a gyroscope to determine the orientation of the mobile device 600. Using the location component 636, the mobile device 600 can generate and/or receive data to identify its geographic location, or to transmit data used by other devices to determine the location of the mobile device 600. The location component 636 may include multiple components for determining the location and/or orientation of the mobile device 600.

The illustrated mobile device 600 also can include a power source 638. The power source 638 can include one or more batteries, power supplies, power cells, and/or other power subsystems including alternating current (“AC”) and/or direct current (“DC”) power devices. The power source 638 also can interface with an external power system or charging equipment via a power I/O component 640. Because the mobile device 600 can include additional and/or alternative components, the above embodiment should be understood as being illustrative of one possible operating environment for various embodiments of the concepts and technologies described herein. The described embodiment of the mobile device 600 is illustrative, and therefore should not be construed as being limiting in any way.

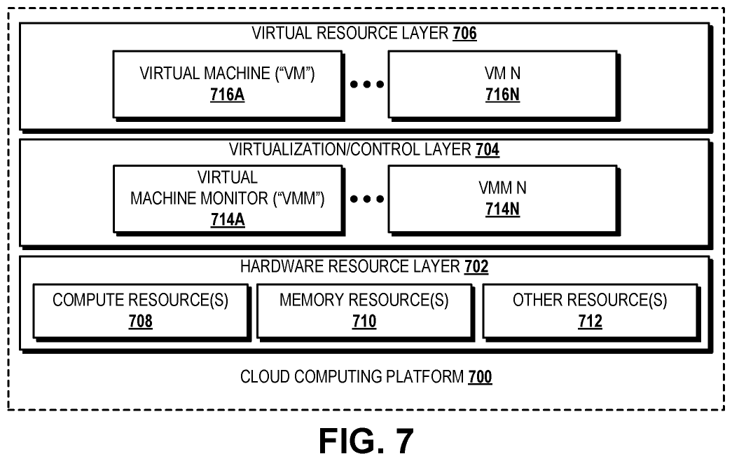

FIG. 7 illustrates an illustrative architecture for a cloud computing platform 700 that can be capable of executing the software components described herein for over-the-air CBRS certificate installation and/or for interacting with the CBRS application 108, the CBRS certificate service 114, the CBRS certificate hosting server 120, the computing device 124, and/or other devices, applications, and/or entities. Thus, it can be appreciated that in some embodiments of the concepts and technologies disclosed herein, the cloud computing platform 700 illustrated in FIG. 7 can be used to provide the functionality described herein with respect to the server computer 116, the CBRS certificate hosting server 120, the computing device 124, and/or other devices.

The cloud computing platform 700 thus may be utilized to execute any aspects of the software components presented herein. Thus, according to various embodiments of the concepts and technologies disclosed herein, the CBRS certificate service 114, the CBRS certificate hosting server 120, and/or other devices and/or services can be implemented, at least in part, on or by elements included in the cloud computing platform 700 illustrated and described herein. Those skilled in the art will appreciate that the illustrated cloud computing platform 700 is a simplification of but only one possible implementation of an illustrative cloud computing platform, and as such, the illustrated cloud computing platform 700 should not be construed as being limiting in any way.

In the illustrated embodiment, the cloud computing platform 700 can include a hardware resource layer 702, a virtualization/control layer 704, and a virtual resource layer 706. These layers and/or other layers can be configured to cooperate with each other and/or other elements of a cloud computing platform 700 to perform operations as will be described in detail herein. While connections are shown between some of the components illustrated in FIG. 7, it should be understood that some, none, or all of the components illustrated in FIG. 7 can be configured to interact with one another to carry out various functions described herein. In some embodiments, the components are arranged so as to communicate via one or more networks such as, for example, the network 104 illustrated and described hereinabove (not shown in FIG. 7). Thus, it should be understood that FIG. 7 and the following description are intended to provide a general understanding of a suitable environment in which various aspects of embodiments can be implemented, and should not be construed as being limiting in any way.

The hardware resource layer 702 can provide hardware resources. In the illustrated embodiment, the hardware resources can include one or more compute resources 708, one or more memory resources 710, and one or more other resources 712. The compute resource(s) 708 can include one or more hardware components that can perform computations to process data, and/or to execute computer-executable instructions of one or more application programs, operating systems, services, and/or other software including, but not limited to, the CBRS application 108, the CBRS certificate service 114, the CBRS certificate hosting server 120, and/or other entities illustrated and described herein.

According to various embodiments, the compute resources 708 can include one or more central processing units (“CPUs”). The CPUs can be configured with one or more processing cores. In some embodiments, the compute resources 708 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 708 can include one or more discrete GPUs. In some other embodiments, the compute resources 708 can include one or more CPU and/or GPU components that can be configured in accordance with a co-processing CPU/GPU computing model. Thus, it can be appreciated that in some embodiments of the compute resources 708, a sequential part of an application can execute on a CPU and a computationally-intensive part of the application can be accelerated by the GPU. It should be understood that this example is illustrative, and therefore should not be construed as being limiting in any way.

In some embodiments, the compute resources 708 also can include one or more system on a chip (“SoC”) components. It should be understood that an SoC component can operate in association with one or more other components as illustrated and described herein, for example, one or more of the memory resources 710 and/or one or more of the other resources 712. In some embodiments in which an SoC component is included, the compute resources 708 can be or can include one or more embodiments of the SNAPDRAGON brand family of SoCs, available from QUALCOMM of San Diego, Calif.; one or more embodiment of the TEGRA brand family of SoCs, available from NVIDIA of Santa Clara, Calif.; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Tex.; one or more customized versions of any of the above SoCs; and/or one or more other brand and/or one or more proprietary SoCs.

The compute resources 708 can be or can include one or more hardware components arranged in accordance with an ARM architecture, available for license from ARM HOLDINGS of Cambridge, United Kingdom. Alternatively, the compute resources 708 can be or can include one or more hardware components arranged in accordance with an x86 architecture, such as an architecture available from INTEL CORPORATION of Mountain View, Calif., and others. Those skilled in the art will appreciate the implementation of the compute resources 708 can utilize various computation architectures and/or processing architectures. As such, the various example embodiments of the compute resources 708 as mentioned hereinabove should not be construed as being limiting in any way. Rather, implementations of embodiments of the concepts and technologies disclosed herein can be implemented using compute resources 708 having any of the particular computation architecture and/or combination of computation architectures mentioned herein as well as other architectures.

Although not separately illustrated in FIG. 7, it should be understood that the compute resources 708 illustrated and described herein can host and/or execute various services, applications, portals, and/or other functionality illustrated and described herein. Thus, the compute resources 708 can host and/or can execute the CBRS application 108, the CBRS certificate service 114, functionality associated with the CBRS certificate hosting server 120, or other applications or services illustrated and described herein.

The memory resource(s) 710 can include one or more hardware components that can perform or provide storage operations, including temporary and/or permanent storage operations. In some embodiments, the memory resource(s) 710 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 708, subject to the definition of “computer storage media” provided above (e.g., as excluding waves and signals per se and/or communication media as defined in this application).

Although not illustrated in FIG. 7, it should be understood that the memory resources 710 can host or store the various data illustrated and described herein including, but not limited to, the CBRS credentials 110, the CBRS certificate request 112, the CBRS certificate 118, and/or other data, if desired. It should be understood that this example is illustrative, and therefore should not be construed as being limiting in any way.

The other resource(s) 712 can include any other hardware resources that can be utilized by the compute resources(s) 708 and/or the memory resource(s) 710 to perform operations. The other resource(s) 712 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 702 can be virtualized by one or more virtual machine monitors (“VMMs”) 714A-714N (also known as “hypervisors;” hereinafter “VMMs 714”). The VMMs 714 can operate within the virtualization/control layer 704 to manage one or more virtual resources that can reside in the virtual resource layer 706. The VMMs 714 can be or can include software, firmware, and/or hardware that alone or in combination with other software, firmware, and/or hardware, can manage one or more virtual resources operating within the virtual resource layer 706.

The virtual resources operating within the virtual resource layer 706 can include abstractions of at least a portion of the compute resources 708, the memory resources 710, the other resources 712, or any combination thereof. These abstractions are referred to herein as virtual machines (“VMs”). In the illustrated embodiment, the virtual resource layer 706 includes VMs 716A-716N (hereinafter “VMs 716”).

Based on the foregoing, it should be appreciated that systems and methods for over-the-air CBRS certificate installation have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a processor; and
a memory that stores computer-executable instructions that, when executed by the processor, cause the processor to perform operations comprising
detecting, at a device, a connection with a user device via a non-CBRS communication band,
authenticating the user device to communicate with the device,
receiving a request for a CBRS certificate, wherein the request for the CBRS certificate is signed by the user device using a private key,
determining, based on the private key, if the user device is in possession of an authorized private key,
in response to a determination that the user device is in possession of the authorized private key, obtaining, from a CBRS certificate hosting server, the CBRS certificate, and
providing, to the user device, the CBRS certificate.

2. The system of claim 1, wherein obtaining the CBRS certificate comprises passing an application programming interface call to the CBRS certificate hosting server to request the CBRS certificate from the CBRS certificate hosting server.

3. The system of claim 2, wherein the application programming interface call comprises a representational state transfer application programming interface call.

4. The system of claim 1, wherein the non-CBRS communication band comprises a long term evolution communication band that is not long term evolution band forty-eight, and wherein the CBRS communication band comprises the long term evolution band forty-eight.

5. The system of claim 1, wherein authenticating the user device comprises challenging the user device for a login and password that were stored in a secure memory of the user device by a device manufacturer, and wherein the user device is configured to store the CBRS certificate in the secure memory of the user device.

6. A method comprising:
detecting, at a device comprising a processor, a connection with a user device via a non-CBRS communication band;
authenticating, by the processor, the user device to communicate with the device;
receiving, by the processor, a request for a CBRS certificate, wherein the request for the CBRS certificate is signed by the user device using a private key;
determining, by the processor and based on the private key, if the user device is in possession of an authorized private key;
in response to a determination that the user device is in possession of the authorized private key, obtaining, by the processor and from a CBRS certificate hosting server, the CBRS certificate; and
providing, by the processor and to the user device, the CBRS certificate.

7. The method of claim 6, wherein determining that the user device is in possession of the private key comprises determining if a copy of the private key stored by the device matches the private key used to sign the request for the CBRS certificate.

8. The method of claim 6, wherein obtaining the CBRS certificate comprises passing an application programming interface call to the CBRS certificate hosting server to request the CBRS certificate from the CBRS certificate hosting server.

9. The method of claim 8, wherein the application programming interface call comprises a representational state transfer application programming interface call.

10. The method of claim 6, wherein the non-CBRS communication band comprises a long term evolution communication band that is not long term evolution band forty-eight.

11. The method of claim 6, wherein the CBRS communication band comprises the long term evolution band forty-eight.

12. The method of claim 6, wherein authenticating the user device comprises challenging the user device for a login and password that were stored in a secure memory of the user device by a device manufacturer.

13. The method of claim 6, wherein the user device is configured to store the CBRS certificate in the secure memory of the user device.

14. The method of claim 13, wherein the user device is configured to execute a CBRS application in a trusted execution environment to sign the request for the CBRS certificate.

15. A computer storage medium having computer-executable instructions stored thereon that, when executed by a processor, cause the processor to perform operations comprising:
detecting, at a device, a connection with a user device via a non-CBRS communication band;
authenticating the user device to communicate with the device;
receiving a request for a CBRS certificate, wherein the request for the CBRS certificate is signed by the user device using a private key;
determining, based on the private key, if the user device is in possession of an authorized private key;
in response to a determination that the user device is in possession of the authorized private key, obtaining, from a CBRS certificate hosting server, the CBRS certificate; and
providing, to the user device, the CBRS certificate.

16. The computer storage medium of claim 15, wherein determining that the user device is in possession of the private key comprises determining if a copy of the private key stored by the device matches the private key used to sign the request for the CBRS certificate.

17. The computer storage medium of claim 15, wherein obtaining the CBRS certificate comprises passing an application programming interface call to the CBRS certificate hosting server to request the CBRS certificate from the CBRS certificate hosting server, and wherein the application programming interface call comprises a representational state transfer application programming interface call.

18. The computer storage medium of claim 15, wherein the non-CBRS communication band comprises a long term evolution communication band that is not long term evolution band forty-eight, and wherein the CBRS communication band comprises the long term evolution band forty-eight.

19. The computer storage medium of claim 15, wherein the user device is configured to store the CBRS certificate in a secure memory of the user device.

20. The computer storage medium of claim 19, wherein the user device is configured to execute a CBRS application in a trusted execution environment to sign the request for the CBRS certificate.
